(19) United States
(12) Patent Application Publication
(10) Pub. No.: US 2016/0154419 A1
(43) Pub. Date: Jun. 2, 2016

(54) STRUCTURE FOR REDUCING CLUTCH PEDAL EFFORT

(71) Applicant: Hyundai Motor Company, Seoul (KR)

(72) Inventor: Yong-Ik KIM, Hanam-si (KR)

(21) Appl. No.: 14/920,732

(22) Filed: Oct. 22, 2015

(30) Foreign Application Priority Data
Dec. 2, 2014 (KR) 10-2014-0170492

(51) Int. Cl. G05G 7/04; G05G 1/44; G05G 1/04; B60K 23/02

(52) U.S. Cl. CPC G05G 7/04; B60K 23/02; G05G 1/44; G05G 1/04

(57) ABSTRACT

A structure for reducing a clutch pedal effort includes a pedal member having a spring bracket disposed at one upper side of the pedal member. A pedal arm coupled to the pedal member by means of a hinge has a spring lever rotatably mounted at an upper side of the hinge. A coil spring is coupled to the spring bracket and the spring lever. A first point at which the coil spring is coupled to the spring lever is positioned to be further rearward and higher than a central point of the hinge, and a second point at which the coil spring is coupled to the spring bracket is positioned to be further forward and lower than the central point. The coil spring is configured to extend rearward when the spring lever rotates by an operation of the pedal.

### CROSS-REFERENCE TO RELATED APPLICATIONS

This application claims the benefit of priority under 35 U.S.C. §119 to Korean Patent Application No. 10-2014-170492, filed on Dec. 2, 2014, in the Korean Intellectual Property Office, the disclosure of which is incorporated herein by reference in its entirety.

### TECHNICAL FIELD

The present disclosure relates to a structure of a clutch pedal, and more particularly, to a structure in which a coil spring having a portion, which passes over an upper portion of a hinge and is bent, is applied to a structure for coupling a pedal member and a pedal arm, thereby reducing a pedal effort for a clutch pedal.

### BACKGROUND

In general, a clutch pedal for a vehicle is a device that is connected with a clutch oil pressure gauge at a transmission side and used to disengage the power transmission of the vehicle at the time of a gear shift operation. A pedal member is fixedly installed on a dash panel disposed below a driver seat, and a pedal arm is rotatably coupled to the pedal member and operated.

A pedal spring, which provides a pedal effort to a driver and allows the pedal to return back, is connected to the pedal arm, and a master cylinder, which generates oil pressure, is installed to be connected with a rod.

However, because the aforementioned clutch pedal structure in the related art is configured to use a pedal spring having a predetermined elastic coefficient so as to conform to safety regulations that are prescribed for each country, there is a problem in that the pedal effort for the pedal cannot be adjusted to a desired degree unless the pedal spring is replaced with a new one.

The clutch pedal structure for a vehicle, which is mass-produced at present, uses a torsion spring and a turn-over spring. The configuration using the torsion spring has advantages in that a structure thereof is simple, cost is reduced, and hysteresis is small, but has a drawback in that it is difficult to sense shifting because there is no section in which the pedal effort decreases.

The configuration using the turn-over spring has an advantage in that the pedal effort decreases after a certain point of time, but has drawbacks in that cost is high, it is difficult to return back, and hysteresis is excessively large, and also has a problem in that when a capacity of a clutch is low, it is impossible to apply the turn-over spring.

Therefore, there is a need for a low-cost clutch pedal structure that improves a sense in shifting when manipulating the clutch pedal so as to reduce a degree of fatigue by the driver, and makes timing of the clutch meet clear so as to easily manipulate the clutch pedal.

### SUMMARY

The present invention has been made in an effort to provide a structure for reducing a clutch pedal effort which may minimize hysteresis, may be advantageous in terms of costs, and may be applied even though a capacity of a clutch is low.

Technical problems to be solved by the present invention are not limited to the aforementioned technical problems, and any other not-mentioned technical problems will be obviously understood from the description below by those skilled in the technical field to which the present invention pertains.

An exemplary embodiment of the present invention provides a structure for reducing a clutch pedal effort, including: a pedal member which has a spring bracket disposed at one upper side of the pedal member; a pedal arm coupled to the pedal member by means of a hinge and having a spring lever that is rotatably mounted at an upper side of the hinge; and a coil spring coupled to the spring bracket and the spring lever. Based on a front and rear direction of the vehicle regardless of whether a pedal is operated, a first point at which the coil spring is coupled to the spring lever is positioned to be further rearward and to be higher than a central point of the hinge, and a second point at which the coil spring is coupled to the spring bracket is positioned to be further forward and to be lower than the central point. The coil spring is configured to extend rearward when the spring lever is rotated by an operation of the pedal.

In certain embodiments, the coil spring may have a bent upward portion that passes over an upper portion of the hinge and is not in contact with the hinge, such that the coil spring is movable corresponding to the rotation of the spring lever.

In certain embodiments, a first virtual straight line that connects the first point and the second point may be positioned further upward than a second virtual straight line that connects the first point and the central point.

In certain embodiments, a damper may be mounted to the coil spring.

In certain embodiments, a bushing may be provided at a portion of the structure where the coil spring is mounted to the spring lever.

According to the structure of the clutch pedal of an embodiment of the present invention, the coil spring having a bent portion that passes over an upper portion of the hinge is applied to a structure for coupling the pedal member and the pedal arm, and as a result, the coil spring may be moved corresponding to the rotation of the spring lever, such that the structure of the clutch pedal may be operated even though a capacity of the clutch is low.

Embodiments of the present invention may reduce costs and hysteresis in comparison with a structure that uses an existing turn-over spring.

### BRIEF DESCRIPTION OF THE DRAWINGS

FIG. 1 is a perspective view of a structure for reducing a clutch pedal effort according to an exemplary embodiment of the present invention.

FIG. 2 is an enlarged perspective view of the structure for reducing a clutch pedal effort according to the exemplary embodiment of the present invention.

FIG. 3 is an exemplified view illustrating an operating mechanism of the structure for reducing a clutch pedal effort according to the exemplary embodiment of the present invention.

FIG. 4 is an exemplified view illustrating an operating force of the structure for reducing a clutch pedal effort according to the exemplary embodiment of the present invention.

### DETAILED DESCRIPTION

Terms or words used in the specification and the claims should not be interpreted as a general and dictionary meaning and should be interpreted as a meaning and a concept which conform to the technical spirit of the present invention based on a principle that an inventor can appropriately define a concept of a term in order to describe his/her own invention by the best method. Therefore, the exemplary embodiments disclosed in the present specification and the configurations illustrated in the drawings are just exemplary embodiments of the present invention and do not fully represent the technical spirit of the present invention. Accordingly, it should be appreciated that various equivalents and modified examples capable of substituting them can be made.

Terms used in the present specification are used only to describe specific exemplary embodiments, and are not intended to limit the present invention. Singular expressions used herein may include plural expressions unless they have definitely different meanings in context.

Embodiments of the present invention may minimize hysteresis, may be advantageous in terms of costs, and may be applied even though a capacity of a clutch is low. Certain embodiments of the present invention include a pedal member 100 which has a spring bracket 110 installed at one upper side of the pedal member 100, a pedal arm 200 which is coupled to the pedal member by means of a hinge 300 and has a spring lever 210 that is rotatably mounted at an upper side of the hinge, and a coil spring 400 which is mounted to the spring bracket and the spring lever. Based on a front and rear direction of a vehicle regardless of whether a pedal is operated, a first point (hereinafter, referred to as ‘point A’) at which the spring lever and the coil spring are coupled to each other is positioned to be further rearward and to be higher than a central point (hereinafter, referred to as ‘point C’) of the hinge, and a second point (hereinafter, referred to as ‘point B’) at which the spring bracket and the coil spring are coupled to each other is positioned to be further forward and to be lower than point C. The coil spring extends rearward while corresponding to rotation of the spring lever by an operation of the pedal, thereby reducing a pedal effort for the pedal.

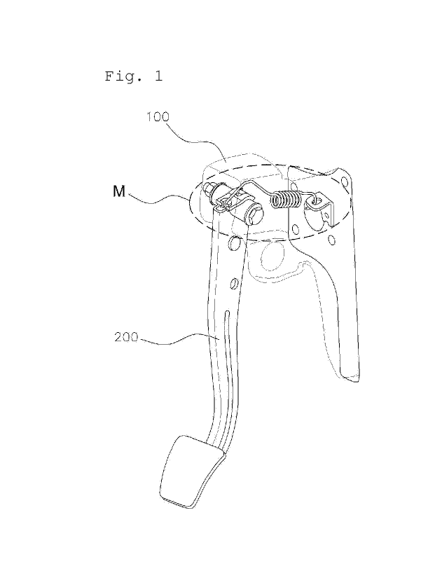

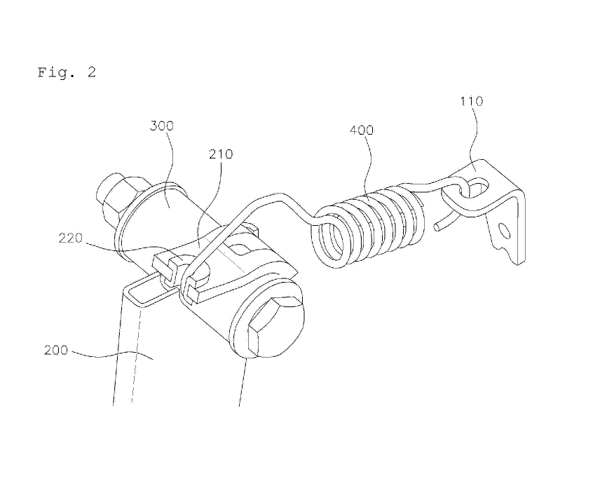

Regarding the aforementioned configuration, FIG. 1 illustrates a perspective view of a structure for reducing a clutch pedal effort according to an exemplary embodiment of the present invention, and FIG. 2 illustrates an enlarged perspective view of part M of FIG. 1 according to the exemplary embodiment of the present invention.

First, the term ‘pedal effort’ mentioned in the present disclosure refers to force required to press the pedal in brief. For example, when force, which is used to actually press a brake pedal in order to brake, is small, it is said that the pedal effort is small. Devices such as a booster are installed in the recent vehicle in order to increase the pedal effort, and as a result, pedal effort performance is remarkably improved in comparison with the related art.

The pedal member 100 of certain embodiments of the present invention is configured to be fixedly installed on a panel (dash panel) below a driver seat, and the spring bracket 110 is installed in a front direction of the vehicle, that is, in a rear direction of the pedal. The coil spring 400 to be described below is connected to the spring bracket, and this connection may be made in various ways, but as illustrated in the drawings, this connection may be made by inserting one end of the coil spring into a hole formed in the spring bracket.

A pedal arm 200 is rotatably coupled to the pedal member 100 by means of a hinge 300. In certain embodiments, a pad, which a driver may manipulate with a foot, is provided at a lower portion of the pedal arm, and the spring lever 210 is rotatably mounted to an upper portion of the hinge. In certain embodiments, the spring lever may be welded on the hinge, and may be rotated together with the hinge when the hinge is rotated by an operation of the pedal arm.

Likewise, the coil spring 400 is connected to the spring lever 210, and in order to prevent abrasion caused by friction between the spring lever and the coil spring when the pedal arm 200 is operated, in certain embodiments, a bushing 220 may be provided at a portion where the spring lever and the coil spring are mounted.

Certain embodiments of the present invention include the coil spring 400 having one side connected to the spring bracket 110 and another side connected to the spring lever 210, and have a structure in which force is transferred to the pedal arm 200 by restoring force of the spring.

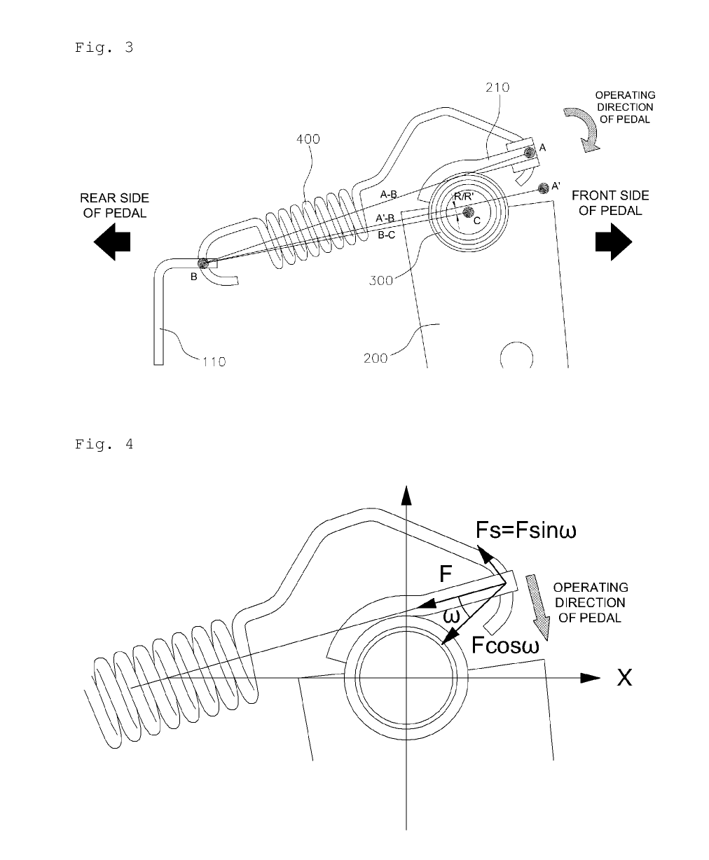

In certain embodiments, a portion of the coil spring 400, which passes over the upper portion of the hinge 300, is formed to be bent upward so as not to be in contact with the hinge. By virtue of this configuration, when the spring lever 210 is rotated by the operation of the pedal arm 200, the coil spring may also be moved corresponding to the rotation of the spring lever 210 without any substantial friction. The mechanism regarding the aforementioned operations is illustrated in FIG. 3 to be described below.

In certain embodiments, as a pad for preventing abnormal noise, a damper may be mounted to the coil spring 400, and as a result, vibrational energy may be absorbed by the damper, thereby exhibiting a shock absorbing effect.

In order to describe operating methods of the aforementioned configurations in detail, FIG. 3 illustrates an exemplified view illustrating an operating mechanism of the structure for reducing a clutch pedal effort according to an exemplary embodiment of the present invention.

First, when defining the respective points illustrated in the drawing:

A corresponds to a point at which the coil spring at the pedal arm side is fixed before the pedal is operated,

A′ corresponds to a point at which the coil spring at the pedal arm side is fixed when the pedal is operated,

B corresponds to a point at which the coil spring at the pedal member side is fixed regardless of whether the pedal is operated,

C corresponds to a central point of the hinge disposed at the upper portion of the pedal arm,

R corresponds to a distance between point C and straight line A-B, and

R′ corresponds to a distance between point C and straight line A′-B.

When describing relationship conditions of the mechanism,

1. point A needs to be positioned further forward and upward than point C based on the pedal,

2. point A′ needs to be positioned further downward than point A when the pedal is operated,

3. straight line A-B and straight line A′-B need to be positioned further upward than straight line B-C when the pedal is operated, and

4. the coil spring is formed to be bent so that there is no interference with the hinge when the pedal is operated.

When briefly describing the operating principle based on the aforementioned conditions, a radius between a central axis of the hinge 300 and an operating line of the coil spring 400 decreases from R to R′ when the pedal is operated, and as a result, the pedal effort decreases.

In order to describe the operating principle in more detail, FIG. 4 illustrates an exemplified view illustrating operating force of the structure for reducing a clutch pedal effort according to the exemplary embodiment of the present invention.

As illustrated in FIG. 4, when F is spring force of the coil spring 400, and Fs is force that is applied to the pedal by the coil spring, the following equation is obtained.

Fs=Fsinw=F\sqrt{(1−cosw²)}\sqrt{(1−cosw²)}

Therefore, when the pedal is operated, an angle formed between the spring lever 210 and the hinge 300 decreases, and as a result, the force Fs which is applied to the pedal arm 200 by the coil spring also decreases. That is, the pedal effort consequently decreases.

As a result, in certain embodiments of the present invention, the coils spring having a portion, which passes over the upper portion of the hinge and is formed to be bent upward so as not to be in contact with the hinge, is applied to the clutch pedal structure, and as a result, an embodiment of the present invention may be applied even though a capacity of a clutch is low, may reduce hysteresis in comparison with the existing configurations, and may also reduce costs.

While the present invention has been described above with reference to a specific exemplary embodiment of the present invention, the exemplary embodiment is merely an example, and the present invention is not limited to the exemplary embodiment. The described exemplary embodiment may be changed or modified by those skilled in the art to which the present invention pertains without departing from the scope of the present invention, and may be variously modified and changed within the technical spirit of the present invention and within the scope equivalent to the appended claims.

What is claimed is:

1. A structure for reducing a clutch pedal effort in a vehicle, the structure comprising:
a pedal member having a spring bracket disposed at one upper side of the pedal member;
a pedal arm coupled to the pedal member by means of a hinge and having a spring lever rotatably mounted at an upper side of the hinge; and
a coil spring coupled to the spring bracket and the spring lever,
wherein based on a front and rear direction of the vehicle regardless of whether a pedal is operated, a first point at which the coil spring is coupled to the spring lever is positioned to be further rearward and to be higher than a central point of the hinge, and a second point at which the coil spring is coupled to the spring bracket is positioned to be further forward and to be lower than the central point, and the coil spring is configured to extend rearward when the spring lever is rotated by an operation of the pedal.

2. The structure of claim 1, wherein the coil spring has a bent upward portion that passes over an upper portion of the hinge and is not in contact with the hinge, such that the coil spring is movable corresponding to the rotation of the spring lever.

3. The structure of claim 1, wherein a first virtual straight line that connects the first point and the second point is positioned further upward than a second virtual straight line that connects the first point and the central point.

4. The structure of claim 1, further comprising a damper mounted to the coil spring.

5. The structure of claim 1, further comprising a bushing provided at a portion of the structure where the coil spring is mounted to the spring lever.
